(19) United States
(12) Patent Application Publication
(10) Pub. No.: US 2025/0222389 A1
(43) Pub. Date: Jul. 10, 2025

(54) OPERATING METHOD FOR EXHAUST GAS TREATMENT FACILITY

(71) Applicant: KURITA WATER INDUSTRIES LTD., Tokyo (JP)

(72) Inventors: Shingo Harashima, Tokyo (JP); Kazumi Tsukamoto, Tokyo (JP); Koji Nakata, Tokyo (JP)

(73) Assignee: KURITA WATER INDUSTRIES LTD., Tokyo (JP)

(21) Appl. No.: 18/853,139

(22) PCT Filed: May 11, 2023
(86) PCT No.: PCT/JP2023/017654

§ 371 Date: Oct. 1, 2024

(30) Foreign Application Priority Data
May 20, 2022 (JP) 2022-083168

(51) Int. Cl. B01D 47/06; B01D 53/14; B01D 53/18; B01D 53/64; B01D 53/79; C02F 1/66; F23G 7/06; F23J 15/00

(52) U.S. Cl. CPC B01D 47/06; B01D 53/1493; B01D 53/185; B01D 53/64; B01D 53/79; C02F 1/66; F23G 7/06; F23J 15/003; B01D 2252/103; B01D 2257/60; B01D 2258/0216; F23G 2209/142; F23J 2217/50

(57) ABSTRACT

An operating method of an exhaust gas treatment facility, which is a method for operating an exhaust gas treatment facility that treats exhaust gas from an electronic component manufacturing process, the operating method comprising: the exhaust gas treatment apparatus being provided with a wet exhaust gas treatment apparatus including a water sprinkling mechanism; and setting a pH of water in the wet exhaust gas treatment apparatus within 5 to 8. The exhaust gas may contain a tungsten compound.

### TECHNICAL FIELD

The invention relates to an operating method for an exhaust gas treatment facility, and more specifically relates to an operating method for an exhaust gas treatment facility for treating exhaust gas from a semiconductor manufacturing process, etc.

### RELATED ART

Exhaust gas containing perfluoro compounds, etc., is discharged from manufacturing processes of semiconductors, liquid crystals, LEDs, solar cells, etc. The exhaust gas may also contain WF₆, CH₂F₂, Cl₂, BCl₃, F₂, HF, SiH₄, NH₃, PH₃, tetraethoxysilane (TEOS), triethoxysilane (TRIS), TiCl₄, etc. In a detoxifying apparatus that treats such exhaust gas, after the perfluoro compounds are burned (oxidized) or subjected to a thermal decomposition reaction through combustion, electric heating, plasma, etc., the exhaust gas is scrubbed in a scrubbing chamber incorporated in the apparatus to absorb and remove F₂, etc., in the gas.

As a detoxifying apparatus against the exhaust gas, a water-cooling combustion-type detoxifying apparatus is provided (Patent Document 1). Such detoxifying apparatus is configured to cause water to flow down along the inner wall surface of the combustion chamber, prevent the products of combustion from being attached to the inner wall surface, and protect the inner wall surface from combustion heat.

A wet scrubber as an apparatus for further performing a cleaning treatment on the exhaust gas from a detoxifying apparatus is widely adopted as a cleaning treatment apparatus of exhaust has (Patent Document 2).

### PRIOR ART DOCUMENT(S)

### Patent Document(s)

Patent Document 1: Japanese Laid-open No. 2003-24741
Patent Document 2: Japanese Unexamined Utility Model Application Publication No. S63-66132

### SUMMARY OF INVENTION

### Technical Problem

In the exhaust gas treatment facility, when the exhaust gas from a semiconductor manufacturing process, etc., is treated, deposits may be formed easily in a pipe or inside a wet exhaust gas treatment apparatus including a water sprinkling mechanism such as a scrubbing chamber and a wet scrubber, and a process is required to stop the exhaust gas treatment facility and remove the deposits. Examples of the deposits may include silica or tungsten solid matters. However, other solid matters may also be formed.

In the conventional exhaust gas treatment facilities, if solid matters are formed, the apparatus is stopped, and the operator performs a cleaning process, which is labor, cost, and time-consuming.

In particular, if the exhaust gas contains a large amount of tungsten (W) compounds, such as WF₆, solid matters containing a large amount of tungsten oxides may accumulate in the exhaust gas treatment facility, and the exhaust gas pipe or a drainage pipe may be clogged easily.

An objective of the invention is to provide an operating method of an exhaust gas treatment facility capable of suppressing deposits, attachments etc., from being formed in the exhaust gas treatment facility.

### Solution to Problem

An operating method of an exhaust gas treatment facility according to the invention is a method for operating an exhaust gas treatment facility that treats exhaust gas from an electronic component manufacturing process. The operating method includes: the exhaust gas treatment apparatus being provided with a wet exhaust gas treatment apparatus including a water sprinkling mechanism; and setting a pH of water in the wet exhaust gas treatment apparatus within 5 to 8.

According to an aspect of the invention, the exhaust gas treatment facility has: a detoxifying apparatus, having a reaction chamber and a scrubbing chamber, wherein the reaction chamber performs a combustion or decomposition treatment on exhaust gas by using heat, and the scrubbing chamber treats exhaust gas from the reaction chamber; and a wet scrubber, to which gas from the detoxifying apparatus is guided. The scrubbing chamber and the wet scrubber are each provided, at an upper part, with a water sprinkling nozzle as the water sprinkling mechanism. a pH of at least one of water circulating through a bottom part of the scrubbing chamber and the water sprinkling nozzle and water circulating through a bottom part of the wet scrubber and the water sprinkling nozzle is set within 5 to 8.

According to an aspect of the invention, the detoxifying apparatus has the reaction chamber and the water sprinkling mechanism, the exhaust gas is guided into the reaction chamber, and the water sprinkling mechanism causes water to flow along an inner wall surface of the reaction chamber. A pH of water flowing out from the water sparkling mechanism and a pH of water accumulating at a bottom part of the reaction chamber are set within 5 to 8.

According to an aspect of the invention, the exhaust gas contains a tungsten compound.

According to an aspect of the invention, the pH of the water is temporarily set to a pH of 10 or more.

According to an aspect of the invention, hydrogen peroxide is added to the water.

### Effects of Invention

According to the invention, by arranging the pH of the water of the wet exhaust gas treatment apparatus to be within 5 to 8, the deposits or attachments in the exhaust gas treatment facility can be suppressed from being generated. According to the invention, in particular, the attachment, deposition of products containing a large amount of tungsten oxides can be sufficiently suppressed in the case of treating the exhaust gas containing tungsten (W) compounds.

### BRIEF DESCRIPTION OF DRAWINGS

FIG. 1 is a diagram illustrating a configuration of an exhaust gas treatment facility.

FIG. 2 is a diagram illustrating a configuration of a wet scrubber.

### DESCRIPTION OF EMBODIMENTS

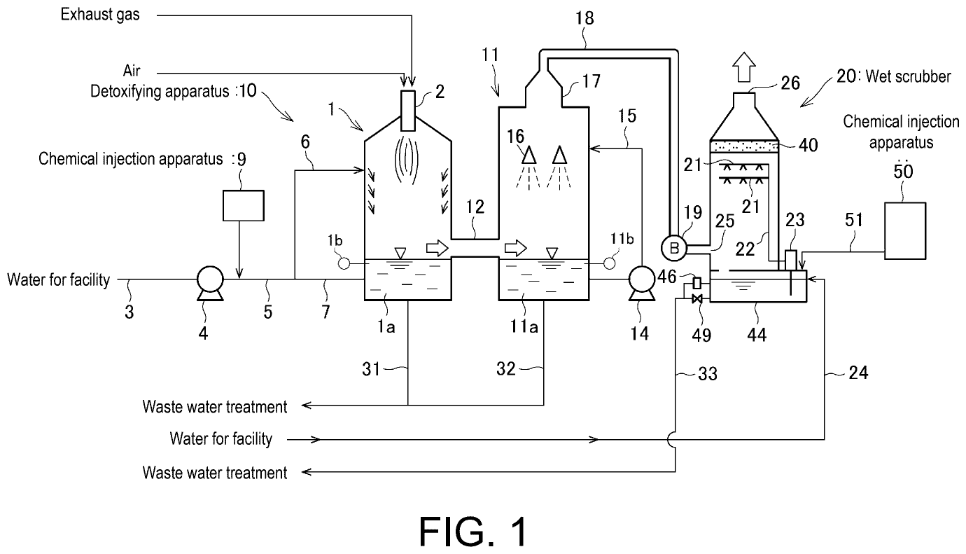

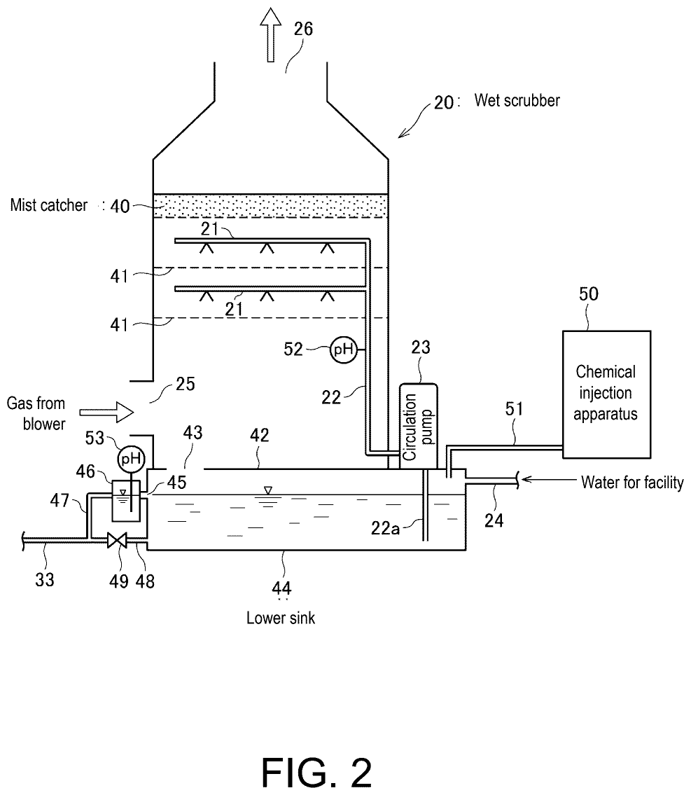

In the following, an example of an exhaust gas treatment facility to which a method according to an embodiment is applied is described with reference to FIGS. 1 and 2.

The exhaust gas treatment facility includes a detoxifying apparatus 10 and a wet scrubber 20. The detoxifying apparatus 10 has a combustion chamber 1 having a tower shape and serving as a reaction chamber and a primary scrubbing chamber 11. Although the detoxifying apparatus 10 and the wet scrubber 20 are described in a one-to-one relationship in the figure, it is common to configure that the gas discharged from multiple (e.g. 10) detoxifying apparatuses 10 is treated by one wet scrubber 20.

Exhaust gas from a semiconductor manufacturing process and air from a blower are supplied to a burner 2 provided at the upper part of the combustion chamber 1, and the exhaust gas is subjected to a combustion treatment in the combustion chamber 1.

The gas generated in an electronic component manufacturing process is suitable as the exhaust gas. Particularly, gas containing tungsten (W) compounds, such as WF₆, is suitable as the exhaust gas. In addition to tungsten compounds, the gas may also contain silane (SiH₄, Si₂H₆, SiH₂Cl₂, etc.,) or other gas components other than silane (B₂H₆, PH₃, NH₃, N₂O, H₂, H₂Se, GeHe, AsH₃, CH₄, C₂H₄, CO, Cl₂, F₂, ClF₃, NF₃, CH₂F₂, NO, O₂, CF₄, C₄F₈, C₅F₈, CHF₃, etc.)

A nozzle (not shown) is provided to cause water to flow along the inner wall surface of the combustion chamber 1, and facility water such as industrial water (water for an industrial purpose) is supplied to the nozzle through a water supply line (pipes 3, 5, 6 and pump 4). The water flowing from the nozzle flows down like a water film through the inner wall surface of the combustion chamber 1, and the inner wall surface is protected from the heat of combustion. With the water flowing like a water film through the inner wall surface of the combustion chamber 1, water soluble components in the combustion gas are absorbed, and micro-particles are captured. In addition, the gas temperature decreases.

The water flowing down through the inner wall surface is accumulated in a pit 1a in the bottom part of the combustion chamber.

As described above, the water supply line to the nozzle has the pipe 3, the pump 4, and the pipes 5 and 6. A joint part of the pipes 5, 6 is connected to an end of the pipe 7. The pipe 7 is provided to supply water to a pit 1a of the bottom part of the combustion chamber 1.

A chemical injection apparatus 9 is provided to inject an alkali agent to the pipe 5. The chemical injection apparatus 9 has a tank for storing an aqueous solution of the alkali agent, a chemical injection pump, and a control circuit for controlling the chemical injection pump.

In the embodiment, pH meters 1b, 11b are respectively provided at the pit 1a and a pit 11a of the primary scrubbing chamber 11, and the detection signals of the pH meters 1b, 11b are transmitted to the control circuit.

The primary scrubbing chamber 11 is provided in adjacency with the combustion chamber 1. The lower part of the combustion chamber 1 and the lower part of the primary scrubbing chamber 11 are in communication through a duct 12. The gas from the combustion chamber 1 is guided into the primary scrubbing chamber 11 via the duct 12 and rises in the primary scrubbing chamber 11.

A portion of the water in the pit 1a of the combustion chamber 1 flows out to a pit 11a of the primary scrubbing chamber 11 due to overflow through the duct 12. A portion of the water in the pit 1a of the combustion chamber 1 may also be transferred to the pit 11a via a water transfer pipe different from the duct 12.

The water of the pit 11a at the bottom part of the primary scrubbing chamber 11 is sprinkled by a water sprinkler 16 via a pump 14 and a pipe 15. The gas that has risen in the primary scrubbing chamber 11 comes into contact with the water sprinkled from the water sprinkler 16, and the water soluble components or micro-particles in the gas are absorbed or captured by water.

The gas that has passed through the primary scrubbing chamber 11 is guided to a wet scrubber 20 via a gas inlet 25 through a duct 18 and a blower 19 from a gas outlet 17.

Water at the bottom part inside the wet scrubber 20 is supplied to a nozzle 21 (water sprinkling mechanism) at the upper part inside the wet scrubber 20 through a circulation pump 23 and a pipe 22. After the gas comes into contact with the water sprinkled from the nozzle 21 and the water soluble components or micro-particles are absorbed or captured by water, the gas flows out from an outlet 26. Facility water is supplemented to the wet scrubber through a pipe 24.

The water at the bottom parts of the combustion chamber 1, the primary scrubbing chamber 11, and the wet scrubber 20 is taken out via pipes 31, 32, 33 and supplied (blown) to a waste water treatment facility (not shown) to be treated.

The detailed configuration of the wet scrubber 20 is as shown in FIG. 2. A mist catcher 40 is provided at the upper part inside the wet scrubber 20. A grating 41 is provided on the lower side of the nozzle 21.

A portion of a lower sink 44 of the wet scrubber 20 projects toward the lateral side, and the pump 23 is provided on the upper side thereof. The water inside the lower sink 44 is suctioned by the pump 23 through a pipe 22a, and is supplied to the nozzle 21 via the pipe 22.

The water sprinkled from the nozzle 21 drops onto an intermediate plate 42 and drops into the lower sink 44 through a water drop hole 43 provided at the intermediate plate 42.

The gas inlet 25 is provided on a wet scrubber sidewall surface upper of the intermediate plate 42.

The pipe 24 is connected to the lower sink 44. An overflow port 45 is provided at an upper position on the side surface of the lower sink 44. When the water level inside the lower sink 44 is higher than the overflow port 45, the water in the lower sink 44 flows to a relay tank 46 from the overflow port 45, and flows from the relay tank 46 to the pipe 33 via the pipe 47.

A pipe 48 is provided for the bottom part inside the lower sink 44 and the pipe 47 to communicate, and a valve 49 is provided at the pipe 48. The valve 49 is opened only for draining water from the lower water tank 44, and is otherwise closed.

An aqueous solution of the alkali agent can be injected from a chemical injection apparatus 50 to the lower sink 44 via a pipe 51. The chemical injection apparatus 50 has a tank for storing the aqueous solution of the alkali agent, a chemical injection pump, and a control circuit for controlling the chemical injection pump.

In the embodiment, pH meters 52, 53 are respectively provided at the pipe 22 and the relay tank 46, and the detection signals of the pH meters 52, 53 are transmitted to the control circuit.

In the embodiment, the alkali agent is added from the chemical injection apparatus 9 to the pipe 5 so that pHs detected by the pH meters 1b, 11b are maintained within 5 to 8. It may also be that, independent from the chemical injection apparatus 9, a chemical injection apparatus dedicated for the scrubbing chamber 11, which adds the alkali agent only to the scrubbing chamber 11, is provided, and the chemical injection apparatus is controlled so that the pH detected by the pH meter 11b is maintained within 5 to 8. In such case, the chemical injection apparatus 9 is controlled so that the pH detected by the pH meter 1b is within 5 to 8.

In addition, in the embodiment, the alkali agent is added from the chemical injection apparatus 50 to the lower sink 44 so that the pHs detected by pH meters 52, 53 are maintained within 5 to 8. Regarding the pH meters, it may be that one of 52, 53 is provided, or a pH meter is provided in addition to 52, 53.

The alkali agent addition control is exerted, for example, so that chemical injection (alkali agent addition) is performed when the detected pH drops below a first reference value (e.g. 7.0), and chemical injection is stopped when the detected pH exceeds a second reference value (e.g., 7.5) higher than the first reference value. Nevertheless, 7.0 and 7.5 merely serve as an example, and the invention is not limited thereto.

In this way, by maintaining the pH of the water of the detoxifying apparatus 10 and the wet scrubber 20 within 5 to 8, the attachment, accumulation of solid matters such as tungsten oxides is suppressed.

It is known that WO3 dissolves in alkaline water. The solubility of WO3 drastically increases when pH is 5 or more, particularly 6 or more. By arranging the pH of the circulating water of the exhaust gas treatment apparatus (the detoxifying apparatus, the scrubber) to be within 5 to 8, WO3 is dissolved and discharged out of the apparatus through blowing. At this time, it suffices as long as WO3 is dispersed and not completely dissolved.

Although the pH control in the invention may be exerted so that the pH constantly falls within 5 to 8, it may be difficult to maintain pH within 5 to 8 with an increased amount of acidic components in the exhaust gas. At such time, the pH may be temporarily increased to, for example, pH 10 to 13 to facilitate the dissolution or dispersion of solid matters such as tungsten oxides.

As the alkali agents, alkali chemical agents, such as inorganic alkali agents like sodium hydroxide, potassium hydroxide, sodium carbonate, potassium carbonate, ammonia, and sodium metasilicate, and organic alkali agents like choline and TMAH are suitable. However, the invention is not limited thereto. Alkali agents may also be waste alkali from an electronic component factory, etc.

In the manufacture of precision parts for semiconductor manufacturing facilities, etc., alkali agents that do not contain metal components, such as NH₃, choline, and TMAH, may be adopted. In addition, by adding H₂O₂ to induce foaming, it is possible to facilitate the decomposition of solid matters.

If pH is set to 5 to 8 (neutral to alkaline), there is a concern that calcium scale and slime may occur. To suppress such occurrence, in addition to the alkali agent, a Ca scale inhibitor and a slime control agent may be added. As the Ca scale inhibitor, examples may include the following: inorganic polyphosphates such as sodium hexametaphosphate and sodium tripolyphosphate, phosphonic acids such as hydroxyethylidene diphosphonic acid and phosphonobutane tricarboxylic acid; carboxyl group-containing compounds such as maleic acid, acrylic acid, and itaconic acid; copolymers in which the above is combined, as necessary, with a vinyl monomer having a sulfonic acid group, such as vinyl sulfonic acid, allyl sulfonic acid, or 2-methacrylamide-2-methylpropanesulfonic acid, or a nonionic vinyl monomer, such as acrylamide. As the slime control agent, examples may include the following: dichloroglyoxime (DCG), 2,2-dibromo-2-nitroethanol (DBNE), 2,2-dibromo-3-nitrilopropionamide (DBNPA), dibromo-2-nitroethanol (BBAB), chloromethisothiazoline (Cl-MIT).

In addition, when Ca ions are present in the water (industrial water, etc.) supplied to the exhaust gas treatment apparatus, as solid matters precipitate, soft water or pure water with a low Ca ion concentration may be used as the supply water.

The embodiment is merely an example of the invention, and the invention may also be embodied in other forms than those described above. For example, in the embodiment, the pH meters are respectively disposed at two positions in each of the detoxifying apparatus 10 and the wet scrubber 20. However, the pH meters may also be respectively disposed at one position or three or more positions.

In the embodiment, the detoxifying apparatus 10 is of a “combustion type”. However, the invention is not limited thereto. The apparatus may also perform detoxification by using heat such as electric heating or plasma heating. In addition, although the combustion chamber 1 has the water sprinkling mechanism (the nozzle that causes water to flow along the inner wall surface), such facility may also be omitted.

In addition, in the embodiment, the alkali agent is added to all the apparatuses of the combustion chamber 1, the primary scrubbing chamber 11, and the wet scrubber 20, so that the pH of the circulating water, etc., is maintained within 5 to 8. However, it may also be that pH is maintained within 5 to 8 in one of the apparatuses. It is noted that the alkali agent may be added to all the apparatuses where solid matters with WO₃ as the main component accumulate easily to maintain the pH within 5 to 8. Moreover, the embodiment has the scrubbing chamber and the wet scrubber. However, it may also be that only one of the scrubbing chamber and the wet scrubber is provided, or multiple scrubbing chambers are provided.

### EXAMPLES

### Test Example 1

In order to investigate the presence state (colloidal, ionic) of WO₃ at each pH, dissolution tests of WO₃ were carried out at different pH levels.

### <Test Method>

(1) Nitric acid was added to 500 mL of ultrapure water to prepare four types of solutions with pHs of 1.5, 2, 4, and 6.
(2) 100 mg of special-grade WO₃ powder was added to each of the solutions in (1) and stirred thoroughly. Then the solutions were left to stand for 24 hours.
(3) 10 mL of supernatant was collected from each of the solutions in (2), and the concentration of tungsten was measured by ICP-MS.

The results (the concentration of tungsten in the supernatant) are as follows, and it is found that WO₃ was easily dissolved at a pH of 4 or higher. It is considered that WO₃ was more easily ionized at a pH of 4 or higher.

### <Concentration of Tungsten in Supernatant>

pH1. 5:7 mg/L
pH2: 8 mg/L
pH4: 46 mg/L
pH6: 67 mg/L

### Test Example 2

The fractionation of WO₃ at each pH was performed. The test method is as follows.

### <Test Method>

(1) Solutions prepared by adding 100 mg of special-grade WO₃ powder to 500 mL of ultrapure water were adjusted to pH 3, 5, or 7 using HNO₃/NaOH.
(2) Each solution of (1) was left to stand for 24 hours.
(3) 250 mL of each solution of (2) was filtered through a filter having a pore size of 0.45 μm.
(4) The concentration of tungsten (W) of each of the 250 mL of the unfiltered liquid and 250 mL of the filtered liquid obtained in (3) was measured by ICP-MS.

The results are as shown in Table 1.

TABLE 1

| | Tungsten concentration of | Tungsten concentration |
|---|---|---|
| pH | unfiltered water (mg/L) | of filtered water (mg/L) |
| 3 | 48 | 16 |
| 5 | 37 | 10 |
| 7 | 47 | 42 |

### <Inspection>

According to Table 1, the tungsten components were removed by using the filter of 0.45 μm when the pH was 3 and 5. However, at pH 7, the W component permeated the filter. It is considered that this is because the tungsten components were ionized and permeated the filter at pH 7.

### Test Example 3

### <Test Method>

500 mL of each of the aqueous solutions of NaOH, choline, ammonia (NH₃), choline+H₂O₂, and ammonia+H₂O₂ was prepared (the alkali concentration was 1 wt %, 0.1 wt %, or 0.01 wt %; the H₂O₂ concentration was the same as the alkali concentration in wt %).

For comparison, 500 mL of ultrapure water (UPW) was also prepared.

300 mg of special-grade WO₃ powder was added to each of the solutions and ultrapure water. The solutions were stirred for 10 minutes, and then filtered and suctioned using a glass filter with a pore size of 1 μm.

In addition, the filtration residue was dried at 120° C. for 12 hours, and then the weight was measured, and the proportion of WO₃ that had permeated the glass filter was calculated as the dissolution rate. The results are as shown in Table 2.

TABLE 2

| | | pH | | Dissolution |
|---|---|---|---|---|
| | | Before | After | rate |
| Solution | Wt % | dissolution | dissolution | [%] |
| UPW | — | — | 4.02 | 10.0 |
| NaOH | 1 | 12.62 | 12.52 | 44.8 |
| | 0.1 | 11.62 | 11.21 | 22.5 |
| | 0.01 | 10.51 | 6.17 | 21.3 |
| Choline | 1 | 13.08 | 13.01 | 87.6 |
| | 0.1 | 12.14 | 11.92 | 57.1 |
| | 0.01 | 11.15 | 6.06 | 28.0 |
| NH₃ | 1 | 11.80 | 11.14 | 86.2 |
| | 0.1 | 11.20 | 10.35 | 69.6 |
| | 0.01 | 10.82 | 9.44 | 42.0 |
| Choline + H₂O₂ | 1 | 11.11 | 11.11 | 86.9 |
| | 0.1 | 11.18 | 10.97 | 49.1 |
| | 0.01 | 10.93 | 8.87 | 28.4 |
| NH₃ + H₂O₂ | 1 | 10.58 | 10.53 | 74.9 |
| | 0.1 | 10.55 | 10.45 | 50.6 |
| | 0.01 | 10.50 | 10.15 | 26.6 |

### <Inspection>

As shown in Table 2, the higher the alkali concentration, the higher the solubility. In addition, even when H₂O₂ was added in an amount equal to that of alkali, there was no significant change in the dissolution rate, but the foaming effect was present, and facilitated dissolution was expected.

### Test Example 4

Six beakers (No. 1 to 6) containing 500 mL of a liquid adjusted to pH 3 with HNO₃ were prepared. 100 mg of special-grade WO₃ powder was added to each beaker and stirred for 10 minutes.

Then, MgCl₂ or CaCl₂) was added to each beaker as shown in Table 3 and stirred for 10 minutes. After being left to stand for 24 hours, the dispersion states were observed. The results are as shown in Table 3.

TABLE 3

| No. | Added salt | Status after 24 hours |
|---|---|---|
| 1 | MgCl₂ 1 mg/L | Dispersed |
| 2 | MgCl₂ 10 mg/L | Dispersed |
| 3 | MgCl₂ 100 mg/L | Dispersed |
| 4 | CaCl₂ 1 mg/L | Dispersed |
| 5 | CaCl₂ 10 mg/L | Dispersed |
| 6 | CaCl₂ 100 mg/L | Basically all deposited |

### <Inspection>

As shown in Table 3, when 100 mg/L of CaCl₂) was added, WO₃ precipitated. Therefore, it is considered that soft water or pure water with a low Ca ion concentration may be used as the water to be supplied to the exhaust gas treatment apparatus.

Although the invention has been described in detail with reference to specific embodiments, it will be apparent to those skilled in the art that various modifications can be made without departing from the spirit and scope of the invention.

This application is based on Japanese Patent Application No. 2022-083168 filed on May 20, 2022, the entirety of which is incorporated by reference.

### REFERENCE SIGNS LIST

1: Combustion chamber;
1b: pH meter;
2: Burner;
4: Pump;
10: Detoxifying apparatus;
11: Primary scrubbing chamber;
11b: pH meter;
16: Water sprinkler;
20: Wet scrubber;
21: Nozzle;
23: Circulation pump;
40: Mist catcher;
44: Lower sink;
46: Relay tank;
50: Chemical injection apparatus;
52, 53: pH meter.

The invention claimed is:

1. An operating method of an exhaust gas treatment facility, which is a method for operating an exhaust gas treatment facility that treats exhaust gas from an electronic component manufacturing process, the operating method comprising:
the exhaust gas treatment apparatus being provided with a wet exhaust gas treatment apparatus comprising a water sprinkling mechanism; and
setting a pH of water in the wet exhaust gas treatment apparatus within 5 to 8.

2. The operating method as claimed in claim 1, wherein the exhaust gas treatment facility has:
a detoxifying apparatus, having a reaction chamber and a scrubbing chamber, wherein the reaction chamber performs a combustion or decomposition treatment on exhaust gas by using heat, and the scrubbing chamber treats exhaust gas from the reaction chamber; and
a wet scrubber, to which gas from the detoxifying apparatus is guided,
wherein the scrubbing chamber and the wet scrubber are each provided, at an upper part, with a water sprinkling nozzle as the water sprinkling mechanism, and
a pH of at least one of water circulating through a bottom part of the scrubbing chamber and the water sprinkling nozzle of the scrubbing chamber and water circulating through a bottom part of the wet scrubber and the water sprinkling nozzle of the wet scrubber is set within 5 to 8.

3. The operating method as claimed in claim 2, wherein the detoxifying apparatus has the reaction chamber and the water sprinkling mechanism, the exhaust gas is guided into the reaction chamber, and the water sprinkling mechanism causes water to flow along an inner wall surface of the reaction chamber,
a pH of water flowing out from the water sparkling mechanism of the reaction chamber and a pH of water accumulating at a bottom part of the reaction chamber are set within 5 to 8.

4. The operating method as claimed in claim 1, wherein the exhaust gas contains a tungsten compound.

5. The operating method as claimed in claim 1, wherein the pH of the water is temporarily set to a pH of 10 or more.

6. The operating method as claimed in claim 1, wherein hydrogen peroxide is added to the water.
